(19) United States
(12) Patent Application Publication
(10) Pub. No.: US 2025/0386371 A1
(43) Pub. Date: Dec. 18, 2025

(54) WIRELESS COMMUNICATION METHOD AND USER EQUIPMENT

(71) Applicant: PURPLEVINE INNOVATION COMPANY LIMITED, Hongkong (HK)

(72) Inventor: Chun-Che CHIEN, Hongkong (HK)

(73) Assignee: PURPLEVINE INNOVATION COMPANY LIMITED, Hongkong (HK)

(21) Appl. No.: 18/880,129

(22) PCT Filed: Jun. 30, 2023
(86) PCT No.: PCT/CN2023/105099

§ 371 Date: Dec. 30, 2024

Related U.S. Application Data
(60) Provisional application No. 63/367,388, filed on Jun. 30, 2022.

(51) Int. Cl. H04W 74/0816; H04L 1/1812; H04W 72/0446; H04W 72/25

(52) U.S. Cl. CPC H04W 74/0816; H04L 1/1812; H04W 72/0446; H04W 72/25

(57) ABSTRACT

A wireless communication method. An initiating user equipment (UE) performs channel occupancy time (COT) initiating for a COT based on a channel access scheme and transmits sidelink data and sidelink control information within the COT. A responding UE receives the sidelink data and sidelink control information within the COT and performs a channel access scheme to use the shared COT. The responding UE transmits a sidelink hybrid automatic repeat request (HARQ) feedback in response to the sidelink data. The initiating receives the sidelink HARQ feedback.

### BACKGROUND OF DISCLOSURE

### 1. Field of Disclosure

The present disclosure relates to the field of communication systems, and more particularly, to a wireless communication method and a user equipment.

### 2. Description of Related Art

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is developed further towards the so-called 5G or NR (new radio) systems where one or more cells are supported by a base station known as a gNB.

### TECHNICAL PROBLEM

Regarding NR sidelink resource and channel structure design, several issues of sidelink channel access in unlicensed band are pending, including:
applicable sidelink (SL) channels and signals for UE-to-UE channel occupancy time (COT) sharing;
applicable scenarios, usage, physical layer (PHY) structure for NR sidelink operation to support cyclic prefix extension (CPE);
whether/how to avoid too small physical sidelink feedback channel (PSFCH) capacity;
the locations of PSFCH resources;
whether/how to address PSFCH transmission dropping due to LBT failure; and/or
whether/how to address PSFCH and related PSSCH in different COTs.

### SUMMARY

An object of the present disclosure is to propose a user equipment, a base station, and wireless communication method.

In a first aspect, an embodiment of the invention provides a wireless communication method executable in a user equipment (UE), comprising:
performing channel occupancy time (COT) initiating for a COT based on a channel access scheme;
transmitting sidelink data and sidelink control information within the COT; and
receiving sidelink hybrid automatic repeat request (HARQ) feedback in response to the transmitted sidelink data.

In a second aspect, an embodiment of the invention provides a UE comprising a processor configured to call and run a computer program stored in a memory, to cause a device in which the chip is installed to execute the disclosed method and any combination of embodiments of the disclosed method.

In a third aspect, an embodiment of the invention provides a wireless communication method for execution by a user equipment (UE), comprising:
receiving sidelink data and sidelink control information within a shared channel occupancy time (COT);
performing a channel access scheme to use the shared COT; and
transmitting a sidelink hybrid automatic repeat request (HARQ) feedback in response to the sidelink data.

In a fourth aspect, an embodiment of the invention provides a UE comprising a processor configured to call and run a computer program stored in a memory, to cause a device in which the chip is installed to execute the disclosed method and any combination of embodiments of the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory; an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

Embodiments of the disclosure are provided to address:
new resource and channel structure for efficient channel access in shared spectrum;
requirements of eMBB type scheduling for a UE to efficiently access a sidelink channel over the unlicensed spectrum based on Mode 1 or Mode 2 resource allocation; and/or
requirements of flexible PSFCH resource indication for efficient HARQ feedback of multi-slot scheduling or to increase channel access reliability of PSFCH.

Accordingly, embodiments of the disclosure provide:
flexible configuration resource and channel structure for efficient channel access in shared spectrum;
Mode 1 and Mode 2 resource allocation schemes for consecutive multi-slot scheduling without interrupting by transmission gaps within a COT.
A semi-static or dynamic indication of PSFCH resource locations for efficient HARQ feedback of a SL transmission or improve PSFCH transmission reliability.

At least one or more embodiments of the disclosure provides a technical effect of prolonged utilization of resources within a COT. Prolonged utilization of resources within a COT prevent collisions or loss of channel occupation due to listen before talk (LBT), and hence increase throughput to satisfy eMBB traffic applications, such as AR/VR gaming, direct vehicle communication, video streaming in smart home IoT network, etc.

At least one or more embodiments of the disclosure provides a technical effect of flexible PSFCH location indication. Flexible PSFCH location indication can avoid unnecessary transmission gap due to periodic insertion of PSFCH symbol for every 1, 2 or 4 slot(s), or improve PSFCH channel access reliability based on more PSFCH transmission opportunities. This flexibility facilitates supporting of SL data transmissions with various traffic requirements.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view showing a wireless communication.

FIG. 2 illustrates a schematic view showing an embodiment of the disclosed method.

FIG. 3 illustrates a schematic view showing an example of NR V2X slot structure without PSFCH symbol

FIG. 4 illustrates a schematic view showing an example of NR V2X slot structure with a PSFCH symbol.

FIG. 5 illustrates a schematic view showing an example of a procedure in Embodiment A for gNB conducting Mode 1 resource allocation based on a COT sharing information.

FIG. 6 illustrates a schematic view showing an example of PSSCHs and corresponding PSFCH feedbacks.

FIG. 7 illustrates a schematic view showing an example of the procedure in Embodiment B for determining a PSFCH resource for HARQ feedback based on Mode 1 resource allocation.

FIG. 8 illustrates a schematic view showing an example using start and length indicator value (SLIV) as an implicit indication to indicate whether the last symbol of an SL slot is used as a guard period.

FIG. 9 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

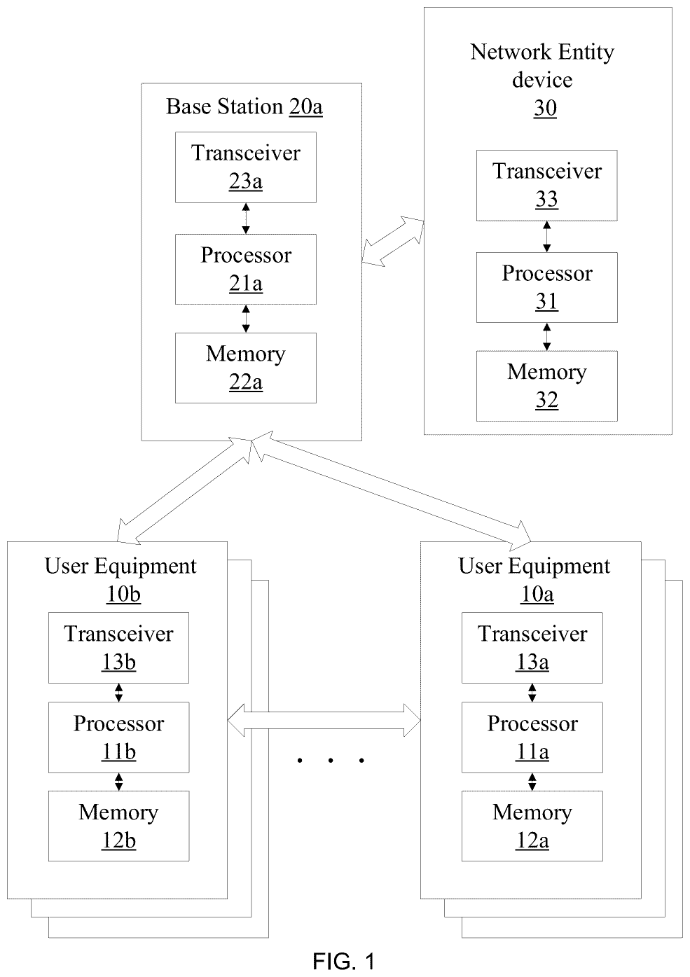

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, and transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Sidelink (SL) transmission of a control signal or data may be a transmission operation from a UE to another UE. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

In the description, a transmitting UE (Tx UE) may be one of the UEs in FIG. 1 which transmits as SL transmission (e.g., PSSCH) to a receiving UE (Rx UE). The Rx UE receiving the SL transmission (e.g., PSSCH) may be one of the other UEs in FIG. 1. The PSSCH is referred to as scheduled PSSCH. HARQ feedback in the description, unless elsewhere specified, means an HARQ feedback in response to the scheduled PSSCH. In the description, HARQ feedback can be simply referred to as feedback.

In the description, gNB, unless elsewhere specified, may be an example of the base station 20a. In the embodiments of the disclosure, gNB may be interpreted as a base station, such as an eNB of LTE, a gNB of NR, or a base station beyond 5G.

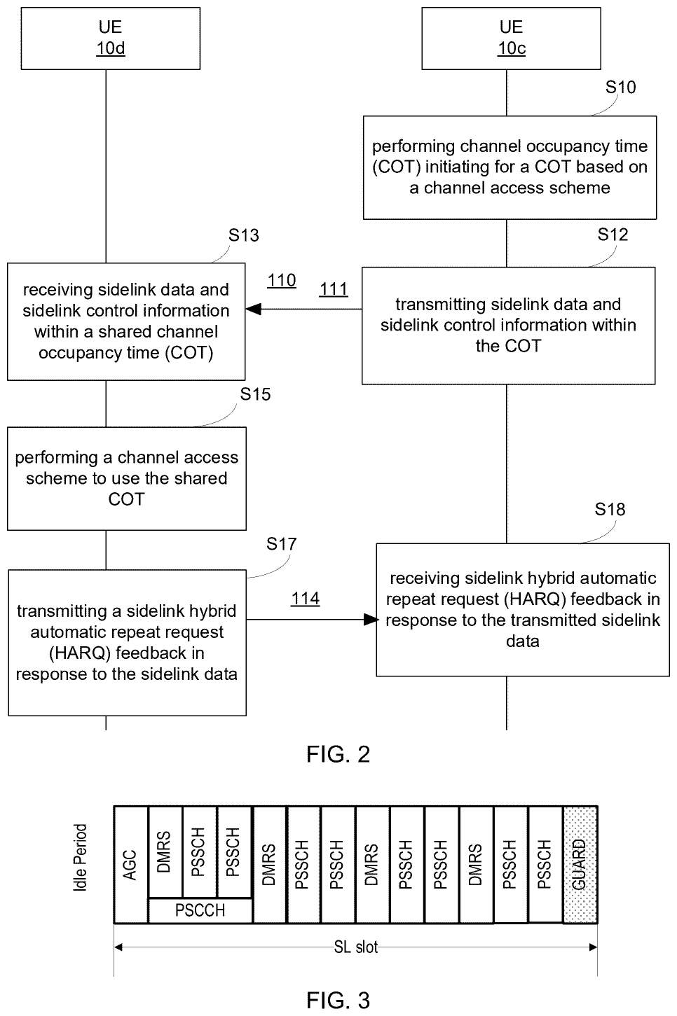

With reference to FIG. 2, a UE 10c and a UE 10d execute an embodiment of a wireless communication method. An example of the UE 10c may include one of the UEs in FIG. 1. An example of the UE 10d may include another one of the UEs in FIG. 1. An example of gNB in the description may include the base station 20a.

An initiating UE 10c performs channel occupancy time (COT) initiating for a COT based on a channel access scheme (S10) and transmits sidelink data 110 and sidelink control information 111 within the COT (S12). A responding UE 10d receives the sidelink data 110 and sidelink control information 111 within the COT (S13) and performs a channel access scheme to use the shared COT (S15). The responding UE10d transmits a sidelink hybrid automatic repeat request (HARQ) feedback 114 in response to the sidelink data 110 (S17). The initiating receives the sidelink HARQ feedback (S18). The sidelink data 110 is transmitted by the initiating UE 10c and received by the responding UE 10d in a sidelink data channel. The sidelink HARQ feedback 114 is transmitted by the responding UE 10d and received by the initiating UE 10c in a sidelink feedback channel located at at least one resource location of multiple resource locations of sidelink feedback channel. The COT used for receiving at least one of multiple resource locations of sidelink feedback channel are initiated by the initiating UE 10c.

In an embodiment, such as embodiment D-5, at least one parameter relevant to the multiple resource locations of sidelink feedback channel associated with the sidelink data channel is pre-configured. The at least one parameter may comprise a maximum number of the multiple resource locations of sidelink feedback channel associated with the sidelink data channel. The at least one parameter may comprise information indicating whether the multiple resource locations of sidelink feedback channel associated with the sidelink data channel are supported.

In an embodiment, a format of the sidelink feedback channel that is to be transmitted at the at least one resource location of the multiple resource locations of sidelink feedback channel are preconfigured.

In an embodiment, such as embodiment D-4, the multiple resource locations of sidelink feedback channel correspond to slot locations or symbol locations, and the multiple resource locations of sidelink feedback channel are preconfigured per RB set or per sidelink resource pool. The multiple resource locations of sidelink feedback channel correspond to one or more than one RB set index or one or more than one RB-based interlace. The multiple resource locations of sidelink feedback channel may be preconfigured per RB set or per sidelink resource pool.

In an embodiment, such as embodiment D-5, the multiple resource locations of sidelink feedback channel are within the same RB set. The multiple resource locations of sidelink feedback channel and a resource location of the sidelink data channel are within the same RB set.

In an embodiment, such as embodiment D-4, the multiple resource locations of sidelink feedback channel are determined based on a minimum PSSCH-to-PSFCH feedback offset, wherein the minimum PSSCH-to-PSFCH feedback offset is a relative time offset between the ending time of the sidelink data channel and the staring time of the sidelink feedback channel.

In an embodiment, such as embodiment D-5, the multiple resource locations of sidelink feedback channel are determined based on a resource location of the sidelink data channel. At least one of the multiple resource locations of sidelink feedback channel are dynamically indicated in the sidelink control information. In an embodiment, such as embodiment D-5, an index of an RB set including the multiple resource locations of sidelink feedback channel are dynamically indicated in the sidelink control information.

In an embodiment, such as embodiment D-4, resource in each of the multiple resource locations of sidelink feedback channel are an RB-based interlace resource.

In an embodiment, such as embodiment C, the at least one resource location of multiple resource locations of sidelink feedback channel are located in a COT different from the COT carrying the sidelink data channel.

Embodiments of sidelink hybrid automatic repeat request (HARQ) feedback schemes and corresponding procedures to support the feature of sidelink operation over unlicensed spectrum (SL-U) are provided to exploit commercial use cases requiring a large amount of data exchanges between UEs while not consuming valuable licensed spectrum. In addition to increasing throughput by harvesting additional bandwidth in unlicensed spectrum, compared to NR-Unlicensed (NR-U) with uplink and downlink operation in unlicensed spectrum, SL-U can reduce the latency of data delivery while offloading the traffic from licensed spectrum to unlicensed spectrum. The extensible services or applications for SL-U include direct vehicle communication, augment reality (AR)/virtual reality (VR) gaming, video streaming in smart home Internet of Things (IoT) network, etc. Enhancements of channel access schemes for sidelink operation over the unlicensed spectrum is necessary to meet both sidelink traffic requirements as well as regulatory requirements of listen-before-talk (LBT) in the unlicensed spectrum. Functional improvement of sidelink operation comprising Mode 1 or Mode 2 resource allocation, resource reservation, and HARQ feedback under the framework of LBE-based or FBE-based channel access scheme. The LBE stands for load-based equipment (LBE), and the FBE stands for frame-based equipment (FBE), load-based equipment (LBE) frame-based equipment (FBE)

NR Vehicle-to-Everything (V2X) defines two resource allocation modes for sidelink communications. which are Mode 1 and Mode 2, each of which corresponds to a centralized scheduling scheme and a distributed scheduling scheme, respectively. In Mode 1, radio resources used for sidelink transmissions are scheduled by an CNB. And in Mode 2, UE (e.g., UE 10a or UE 10b) autonomously selects radio resources from a resource pool configured by gNB before performing sidelink transmissions. Mode 1 resource allocation can only operate in the scenarios where the UEs are inside the coverage of gNB. On the other hand, Mode 2 resource allocation is determined and carried out by UE, therefore can operate either inside or outside of gNB's coverage. In NR V2X, physical sidelink control channel (PSCCH) can be used for carrying sidelink channel information (SCI), physical sidelink shared channel (PSSCH) can be used for carrying sidelink data, and PSFCH can be used for carrying HARQ feedback information of sidelink data received in the PSSCH.

The SCI schedules the resources carried by the PSSCH associated to a transport block (TB), as well as information required for decoding the TB. Different from LTE V2X wherein the SCI is only carried in PSCCH, in NR V2X, the SCI is transmitted in two stages. The first stage SCI is carried on the PSCCH while the second stage SCI is carried on the corresponding PSSCH.

The first stage SCI indicates the frequency resources of the PSSCH as well as the resource reservation for up to two retransmissions of the transport block (TB). The first stage SCI also carries modulation and coding scheme (MCS) of the associated PSSCH, a priority of the associated PSSCH, and a format and size of the second-stage SCI. The second stage SCI carries information used for decoding PSSCH and for supporting HARQ feedback and channel state information (CSI) reporting. The second stage SCI indicates source identifier (ID), destination ID, and whether HARQ feedback is enabled for the received PSSCH. The destination ID indicates an intended receiver of a receiver UE (Rx UE) of the TB, source ID allows an Rx UE to determine the identity of transmitter UE (Tx UE) for HARQ feedback carried on PSFCH. The second stage SCI also carries a new data indicator (NDI) redundancy version (RV), and an HARQ process ID of a corresponding TB. The HARQ stands for hybrid automatic repeat request (HARQ). The purpose of splitting the SCI into two stages allows UEs other than Rx UE to decode only the first stage SCI for channel sensing purposes and determine whether a resource is reserved by other Tx UEs, while the second stage SCI provides additional information on TB decoding and feedback for the Rx UE.

To support sidelink radio access to unlicensed bands, LBT and channel occupancy time (COT) acquisition or COT sharing can be introduced to both Mode 1 and Mode 2 resource allocation schemes in the PC5 interface. For Mode 1 resource allocation, UE (e.g., UE 10a or UE 10b in FIG. 1) should carry out a channel access procedure, i.e., LBT, before sidelink transmission on the scheduled resources. In this case, gNB assesses the channel based on measurement and report from UE (e.g., UE 10a or UE 10b) and may schedule sidelink UE (e.g., UE 10a or UE 10b) through a licensed or unlicensed spectrum of Uu interface to allocate sidelink resource in the unlicensed spectrum of PC5 interface. For Mode 2 resource allocation. UE (e.g., UE 10a or UE 10b) should perform channel sensing, resource selection and channel access procedure before sidelink transmission on the unlicensed spectrum. In order to avoid resource collision for shared resource pool in an unlicensed band, a reservation of sidelink resource indicated in SCI for the current or future sidelink transmission in NR-V2X can be carried over to the unlicensed spectrum. Other sidelink UEs can perform SCI monitoring in the resource pool to determine whether a sidelink resource is occupied or available for sidelink transmission. After determining valid resources and performing resource selection according to a certain rule. UE (e.g., UE 10a or UE 10b) may execute LBT to assess channel availability before acquiring a COT for its own sidelink transmission or share the acquired COTs with other sidelink UEs.

In NR-U, two channel access modes are supported, which are LBE (load-based equipment) based channel access mode and FBE (frame-based equipment) based channel access mode. LBE is also known as a dynamic channel access mode, and FBE is also known as semi-static channel access mode. In LBE channel access, a UE (e.g., UE 10a or UE 10b) may perform an LBT at any time instantly whenever the UE has data in the buffer and initiate a COT for transmissions upon successful LBT. On the other hand, for FBE channel access, one or more UEs only contends for the channel based on LBT at synchronized frame boundaries. A fixed frame period (FFP) among {1 ms, 2 ms, 2.5 ms, 4 ms, 5 ms, 10 ms} is assigned for the FBE device. FFP occurs periodically with a channel occupation time (COT) starting from the beginning and followed by an idle period at the end of the FFP.

For unlicensed band channel access, upon a UE (e.g., UE 10a or UE 10b) initiates a channel occupancy time (COT) after a successful Type 1 LBT, the duration for continuous transmission can be up to maximum COT (MCOT), which depends on channel access priory class (CAPC). A burst transmission, which restricts gaps between any two consecutive transmissions at most 16 μs within a COT, can improve channel access efficiency as well as prevent channel lost due to LBT failures in the middle of COT. The burst transmission can comprise consecutive multi-slot transmission within a COT of the same TB or different TBs sent from a UE initiating the COT or from a UE sharing the COT.

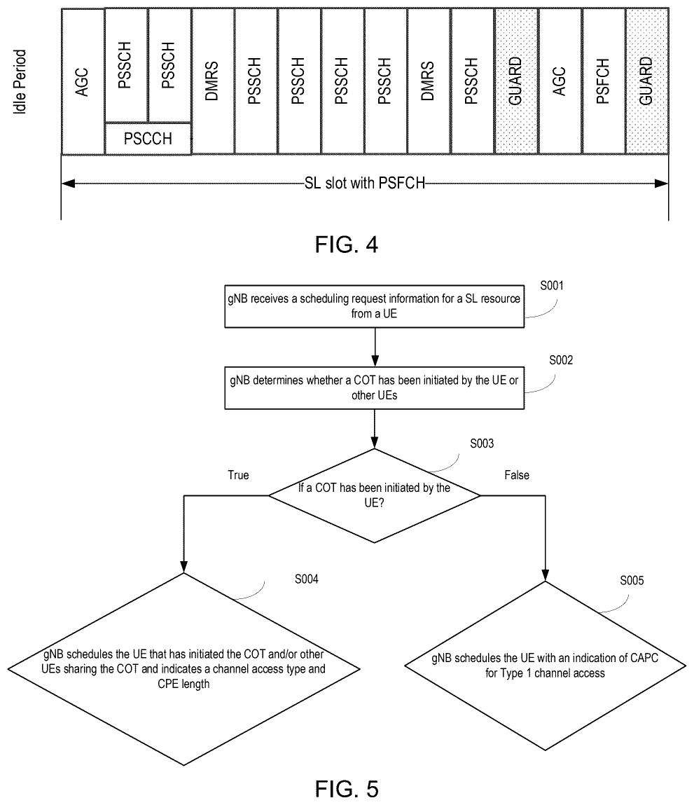

FIG. 3 is an example of NR V2X slot structure without PSFCH symbol while FIG. 4 is an example of NR V2X slot structure with a PSFCH symbol.

As shown in FIG. 3, in current NR SL slot structure with 14 SL symbols with normal cyclic prefix (CP) and 3 symbol PSCCH, and a guard period which allows Tx-Rx or Rx-Tx switching is always present at the end of an SL slot. As shown in FIG. 4, if resources for PSFCH are pre-configured in a resource pool periodically, additional gap is added before a PSFCH symbol for every 1, 2 or 4 slot(s). Since a orthogonal frequency division multiplexing (OFDM) symbol duration is greater than 16 microsecond (μs), i.e., 66.67 μs, 33.3 μs, and 16.67 μs for 15 kHz, 30 kHz, and 60 kHz respectively. It is inevitable that these gaps will interrupt channel occupancy for a UE. Therefore, a flexible slot structure with explicitly or implicitly determined gap location within a slot based on semi-static or dynamic indication should be supported. These gaps can be eliminated or replaced with data symbols to ensure continuous transmission within a COT when no Tx-Rx or Rx-Tx switching is within a slot caused by insertion of PSFCH resource used for HARQ feedback transmission/reception within a slot or when multiple consecutive slots are scheduled. For example, a Tx UE transmits one or more than one TB over consecutive slots to one or more than one Rx UE, or the Tx UE docs not need to transmit or receive HARQ feedback in at least one of the consecutive slots. The HARQ feedback of the scheduled TB(s) can be indicated to be jointly transmitted at the end of the COT. In this case, a gap is added before the PSFCH symbol of the slot indicated for HARQ-ACK transmission or a gap is appended at the end symbol of the last slot of the consecutive multi-slots scheduled by the Tx UE.

On the other hand, if only one PSFCH symbol location is assigned to a PSSCH transmission for a TB or a group of PSSCH transmissions for single or multiple TBs, and the PSFCH may not be transmitted due to failure of LBT, the condition will result in retransmissions and hence exacerbate collision probabilities. In an embodiment, assignment of the same HARQ feedback transmission over more than one PSFCH symbol location or (re)transmitting an HARQ feedback on a later PSFCH location when the UE fails to transmit the HARQ feedback on a previously assigned PSFCH location should be supported.

In this description, embodiments of flexible PSFCH resource indication and transmission gap elimination for HARQ feedback of multi-slot transmissions are provided, wherein the PSFCH resource location and scheduled PSSCH transmission(s) may belong to the same COT or to different COTs. Improvement of SL HARQ feedback operation involves its interactions with COT sharing, resource reservation for PSFCH, and channel access scheme for PSFCH based on SL Mode 1 and Mode 2 resource allocation under the framework of LBE-based or FBE-based channel access scheme over SL unlicensed spectrum.

### Embodiment A

UE (e.g., UE 10a or UE 10b) provides one or more types of the following information to a gNB via gNB detection, e.g., based on demodulation reference signal (DMRS) or PSCCH detection in shared spectrum, or delivered to gNB via uplink control information (UCI), medium access control (MAC) control element (CE), or a radio resource control (RRC) message in the licensed spectrum for the gNB to configure or indicate time and/or frequency resources for SL transmission and HARQ feedback for Mode 1 or Mode 2 resource allocation:
1. A scheduling request (SR) and/or buffer status report (BSR) for SL transmission;
2. COT initiation information or COT sharing information;
3. UE assistance information; and
4. PC5 quality of service (QoS) parameters defined for PC5 communication, e.g., PC5 5QI (PQI).
   These types of the following information are further detailed in the following.
1. A scheduling request (SR) and/or buffer status report (BSR) for SL transmission:

The gNB can rely on the SR and/or BSR to determine whether the UE requesting SL resource(s) and/or to determine the number of resources required by the UE for an SL transmission, e.g., the number of subchannels, and/or one or more slots for SL resource scheduling, etc. The gNB performs SL resource scheduling accordingly. One or more slots SL resource scheduling is SL resource scheduling by which gNB allocates one or more slots to UE (e.g., UE 10a or UE 10b).
2. COT initiation information or COT sharing information:

A gNB can acquire COT initiation information regarding whether a UE has initiated a COT or information of COT sharing based on one of the following schemes:
The gNB detects the information based on DMRS or PSSCH to determine whether a UE has initiated a COT.
The information is transmitted by UE (e.g., UE 10a or UE 10b) via UCI over licensed or shared spectrum. The COT initiation information or COT sharing information can be individually encoded or jointly encoded with SL HARQ feedback or other UCI information or jointly encoded with CG-UCI information in the PUCCH or PUSCH, CG stands for configured grant.

Once a UE (e.g., UE 10a or UE 10b) successfully initiates a COT, the UE can provide a COT structure or COT sharing information to a gNB. The COT structure may be represented by time/frequency location, duration, and/or other information of a COT. The COT sharing information can be indicated using one of a plurality of COT durations pre-configured by the gNB.

The COT sharing information may comprise one or more instances of the following information:
Starting time, ending time, length of a COT for COT sharing, or enable/disable of COT sharing. The starting time of the COT can be the starting point of a slot, mini-slot, or sub-slot carrying the COT sharing information.
A frequency range of a COT sharing, e.g., one or more than one index of interlace, subchannel, or RB set.
One or more than one target of Rx UE(s) for SL transmission within a shared COT.
One or more than one channel type or signal type for SL transmission within a shared COT.

The gNB can rely on the COT initiation information or COT sharing information to determine, configure, or indicate to the UE at least one of the following parameters:
2.1 Mode 1 resource allocation;
2.2 PSSCH-to-PSFCH feedback timing and/or PSFCH resource used for PSFCH feedback; and
2.3 A PSCCH monitoring period, channel control element (CCE) aggregation level, or search space configuration.

The parameters are detailed in the following.
2.1 Mode 1 resource allocation:

The gNB can indicate different resource allocation schemes and corresponding parameters of the schemes to a UE that initiates a COT, a UE that shares a COT, or a UE that does not acquires a COT. Examples are provided in the following.

Depending on the length of an initiated COT, the gNB can determine whether to perform single slot or multi-slot SL resource scheduling. Single slot or multi-slot SL resource scheduling is SL resource scheduling by which gNB allocates one or more slots to UE (e.g., UE 10a or UE 10b).

For a UE (e.g., UE 10a or UE 10b) that does not acquires a COT, in addition to resource allocation parameters (e.g., resource pool index. RB set index, initial index of subchannel or interlace and the number of subchannels or interlaces), additional information for Type 1 channel access (e.g., location or duration for performing channel sensing or CAPC) should be provided to the UE.

For a UE (e.g., UE 10a or UE 10b) that initiates a COT or shares a COT, the scheduled resource should be confined within the COT based on the COT sharing information, and the channel access type (e.g., Type 1/2A/2B/2C), CAPC, or CPE for channel access within a COT can be provided by the UE.
2.2 PSSCH-to-PSFCH feedback timing and/or PSFCH resource used for PSFCH feedback:

If PSFCH feedback timing for HARQ feedback is not within the COT that carries the scheduled SL transmission, HARQ feedback deferral or an HARQ ACK/NACK retransmission procedure described in Embodiment C can be configured by the gNB.
2.3 A PSCCH monitoring period, channel control element (CCE) aggregation level, or search space configuration:

Different sets of the above parameters can be configured by the gNB per SL resource pool or per RB set for a UE (e.g., UE 10a or UE 10b) that monitors a PSCCH within a COT duration or out of a COT duration.
3. UE assistance information:

The UE assistance information provides the expected SL traffic of the UE, e.g., SL traffic type, SL traffic periodicity, SL traffic priority, a maximum TB size, or latency and reliability requirements of a TB.
4. PC5 quality of service (QoS) parameters defined for PC5 communication, e.g., PC5 5QI (PQI):

A PQI (PC5 5G QoS Identifier (5QI)) value is associated with QoS characteristics regarding reliability of the packet transmission, e.g., resource type, priority level, packet error rate (PER), and the latency bound for packet delivery, e.g., packet delay budget (PDB).

CAPC values for PC5 communication can be mapped to different QoS parameters of PC5 communication, so that QoS processing for sidelink may be based on:
4.1 Mapping between the PQI values and class levels of CAPC values; and
4.2 Mapping between the L1 priority levels of PSSCH and class levels of CAPC values.
   4.1:

Mapping between the PQI values and four class levels of CAPC values can be configured with a mapping table, where one or more than one PQI value can be mapped to a CAPC value.

gNB indicates to UE (e.g., UE 10a or UE 10b) a CAPC via RRC signaling or DCI for SL channel access.

Different SL channels or SL signals can correspond to separate PQI-to-CAPC mapping or can be indicated with independent CAPC values.

DL CAPC or UL CAPC defined for NR-U can be reused for SL channel access.

4.2:

Mapping between the L1 priority levels of PSSCH and four class levels of CAPC can be provided by gNB.

The priority of a PSSCH (referred to as PSSCH priority) can be indicated by Tx UE using an L1 priority level or CAPC class level in SCI or indicated by gNB using an L1 priority level or CAPC class level in DCI. PSSCH priority can be used for determining various aspects of sidelink, for example, including one or more of:
Parameter setting relevant to resource selection window and/or resource reservation.
Whether to transmit or receive PSFCH feedback due to half-duplex constraints.
A PSFCH resource used for HARQ feedback or the number of PSFCH transmission occasions.
Collision resolution. If a PSSCH reservation collides in time with a transmission of another PSSCH, only the PSSCH with higher priority can be transmitted.
Power allocation of a PSSCH transmission.

### Embodiment A-1

With reference to FIG. 5, an example of a procedure in Embodiment A for gNB conducting Mode 1 resource allocation based on a COT sharing information acquired from a UE is detailed in the following.

A gNB receives a scheduling request for an SL resource from a UE (e.g., UE 10a or UE 10b) (S001).

The gNB determines whether the UE has initiated a COT based on receiving detecting an SL transmission from the UE. (S002)

If the gNB determines that the UE successfully initiates a COT and acquires COT sharing information from the UE (referred to as initiator UE) (S003), the gNB performs SL resource scheduling for the UE that has initiated the COT and/or another UE (e.g., UE 10b or UE 10a) (referred to as the another UE) that can use the COT shared from the initiator UE. The gNB indicates a corresponding CPE length to the another UE and uses an LBT indication to instruct the another UE. In response to the LBT indication, the another UE performs channel access within the COT based on one of Type 2A, 2B, or 2C channel access scheme and the corresponding CPE length for data transmission within the COT (S004).

Otherwise, if determining that a COT has not been initiated by the UE or other UEs, (S003) the gNB performs SL resource scheduling for the UE and instructs the UE to perform channel access based on Type 1 channel access with a CAPC level indicated by the gNB or determined by the UE. (S005)

### Embodiment B

One or more of the following settings or configurations per SL resource pool or per RB set can be determined based on UE assistance information, CAPC, or a PQI value, and can be configured or indicated by a Tx UE or gNB:
Latency, reliability, and/or priority relevant requirement of SL traffic; and
Pack size and/or TB size relevant requirement(s) of SL traffic.

The settings or configurations per SL resource pool or per RB set are detailed in the following.

The settings or configurations regarding latency, reliability, and/or priority relevant requirement of SL traffic, for example, may include one or more of:
Activation/deactivation of configured grant (CG) scheduling or parameter adjustment (e.g., time-frequency resource, priority, or period) of one or more than one CG configuration.
Activation/deactivation of FBE-based channel access scheme or parameter adjustment (e.g., period or offset parameter) of FBE.
Contention window range adjustment.
Sensing window range or selection window range adjustment.
L1 priority level determination for each of one or more than one SL channel or SL signal.
CAPC or channel access type (Type 1/2A/2B/2C) indication for each of one or more than one SL channel or SL signal.
PSFCH feedback resource assignment (e.g., PSFCH resource size, PSFCH occurrence period, or PSFCH transmission opportunities).
A PSCCH symbol length, PSCCH search space, and size of CCE aggregation level.
Reference Signal Received Power (RSRP) threshold or probability for a UE (e.g., UE 10a or UE 10b) selecting a new SL resource.
Slot format configuration, e.g., slot-based, mini-slot based, or sub-slot based slot format, or subcarrier spacing setting.
Type A (slot-based) or Type B (non-slot based) resource allocation.
Selection of modulation and coding scheme (MCS) table.
Activation of preemption mechanism for overlapped resource reservation.
Flexible transmission gap location.

The settings or configurations regarding pack size and/or TB size relevant requirement of SL traffic, for example, may include one or more of:
The number of subchannels or resource block (RB) sizes assigned for a TB.
The number of RBs assigned for a subchannel.
The number of RB sets within a SL resource pool.
The number of interlaces assigned for an RB set.
Support of single or multi-slot SL scheduling for one or more than one TB

### Embodiment C

For Mode 1 or Mode 2 resource allocation, according to the PSSCH-to-PSFCH processing time requirement, if a PSFCH resource for PSFCH feedback is not within a COT carrying the scheduled PSSCH due to PSFCH channel access failure or PSSCH-to-PSFCH feedback timing restriction, at least one following operation can be adopted.

The HARQ feedback transmission(s) outside of the COT is dropped.

Either a Tx UE that schedules the PSSCH or an Rx UE that receives the PSSCH can initiate a later COT for carrying an HARQ feedback that has not yet been transmitted.

If a Tx UE initiates a later COT, the COT can be shared with the Rx UE for transmission of HARQ feedback on a PSFCH resource. The HARQ feedback may be deferred HARQ feedback that has not been transmitted in the same COT for the scheduled PSSCH transmission.

If a dynamic indication of PSSCH-to-PSFCH feedback timing for each SL transmission is indicated by a gNB (Mode 1 resource allocation) or a Tx UE (Mode 1 or Mode 2 resource allocation), the gNB or the Tx UE may indicate a non-numerical value indication of HARQ-ACK timing for an HARQ-ACK that has not been transmitted in the same COT for the scheduled PSSCH transmission.

The non-transmitted HARQ-ACK can be transmitted together with another HARQ-ACK based on a numerical value indicated for a corresponding PSSCH scheduled at a later COT and uses the same PSFCH resource for the HARQ-ACK of the PSSCH scheduled at the later COT.

The gNB can use a dynamic indication in the DCI to indicate that the non-transmitted HARQ-ACK is to be re-transmitted in a later COT.

The gNB or Tx UE indicates an SL HARQ-ACK retransmission via a DCI or an SCI based on enhanced Type 2 or (enhanced) Type 3 codebook HARQ feedback on a PSFCH resource at a later COT.

The HARQ ID or a range of HARQ IDs for one or more PSSCH in case of HARQ-ACK retransmission can be derived from an HARQ feedback request field in a DCI or SCI.

The HARQ-ACK transmission may be deferred until a first available PSFCH resource on the later COT.

An available PSFCH resource is a PSFCH symbol carried on a slot which is in the coverage of a COT. The location of PSFCH resource can periodically occur and pre-configured per SL resource pool or per RB set via RRC configuration by the gNB or dynamically indicated by the gNB via DCI or by Tx UE via SCI.

The gNB may configure a maximum PSFCH feedback deferral, or a maximum PSSCH-to-PSFCH feedback timing per SL resource pool or per RB set to restrict the HARQ-ACK transmission on a later COT.

If the latency of PSSCH-to-PSFCH feedback after deferral is larger than the maximum PSSCH-to-PSFCH feedback timing, then the non-transmitted HARQ-ACK is skipped.

If the latency of PSSCH-to-PSFCH feedback after deferral until the first available PSFCH resource on a later COT is smaller than the maximum PSSCH-to-PSFCH feedback timing, then the HARQ-ACK transmission will be further deferred to the next available PSFCH resource.

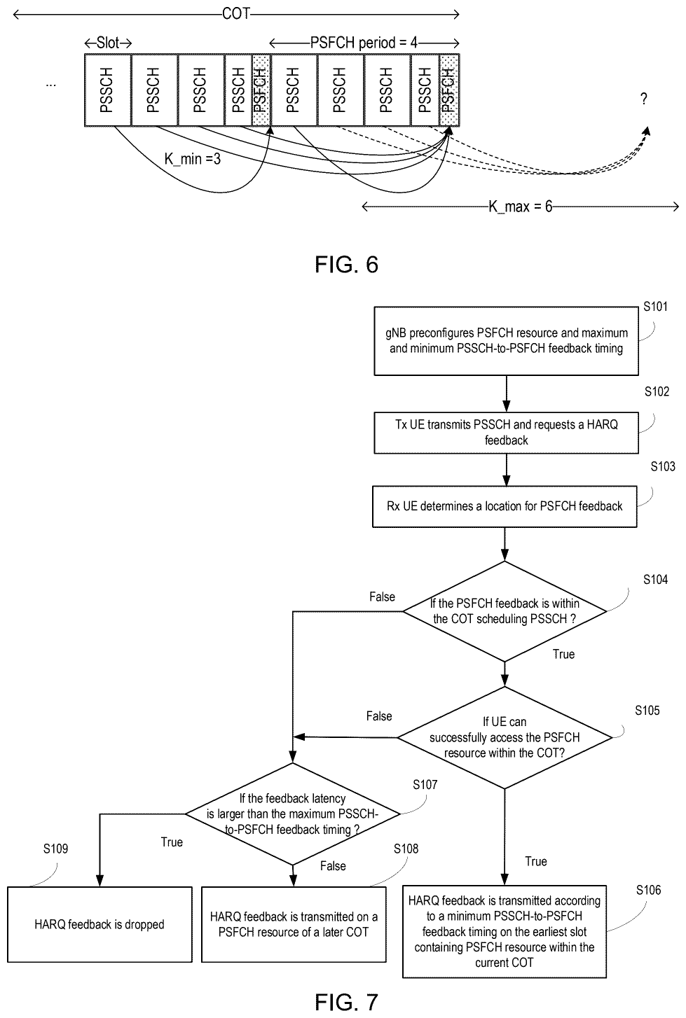

FIG. 6 shows an example of PSSCHs and corresponding PSFCH feedbacks. The association between PSSCHs and corresponding PSFCH feedbacks are shown as arrows. The PSFCH resource periodically occurs for every 4 slots, the minimum PSSCH-to-PSFCH timing K_min=3 slots, and the maximum PSSCH-to-PSFCH timing is K_max=6 slots. The HARQ feedback timing of the last three PSSCHs is outside of the current COT.

### Embodiment C-1

With reference to FIG. 7, an example of the procedure in Embodiment B for determining a PSFCH resource for HARQ feedback based on Mode 1 resource allocation is detailed in the following.

A gNB preconfigures PSFCH resource with a periodicity of n slot(s) as well as a minimum PSSCH-to-HARQ feedback timing of K slot(s) for an SL resource pool or an RB set (S101). The variables n and K are an positive integers.

A Tx UE transmits a PSSCH based on gNB's scheduling and requests an HARQ feedback of the PSSCH (S102).

A Rx UE receives the PSSCH and determines a PSFCH resource for HARQ feedback according to the minimum PSSCH-to-PSFCH feedback timing (S103). The Rx UE transmits HARQ feedback in the PSFCH resource in response to the received PSSCH.

The Rx UE determines whether the location of HARQ feedback is within the COT of the PSSCH (referred to as the current COT) (S104):
If the Rx UE cannot successfully access the PSFCH in the COT due to LBT, and the PSFCH is the last transmission opportunity within the COT (S105), the HARQ feedback procedure is proceeded to step S107.
Otherwise, the HARQ feedback is transmitted according to a minimum PSSCH-to-PSFCH feedback timing on the earliest slot containing a PSFCH resource (e.g., a PSFCH symbol) within the current COT (S106).

If the location of HARQ feedback is outside of the COT of the PSSCH (S104) due to feedback timing restriction or LBT failure (S105), and the PSSCH-to-PSFCH feedback latency is smaller than a maximum PSSCH-to-PSFCH feedback timing (S107), the HARQ feedback is deferred to a later COT and transmitted on a PSFCH resource (e.g., a slot containing a PSFCH symbol) in the later COT. (S108)

If the PSSCH-to-PSFCH feedback latency is not smaller than the maximum PSSCH-to-PSFCH feedback timing, the HARQ feedback is dropped. (S109)

With reference to FIG. 2, in an embodiment, such as embodiment C, the at least one resource location of multiple resource locations of sidelink feedback channel are located in a COT different from the COT carrying the sidelink data channel.

### Embodiment D

A gNB configures at least one of the following parameters for a UE (e.g., UE 10a or UE 10b) or a group of UEs (e.g., UE 10a and UE 10b) to perform SL-U channel access or SL communications. If not otherwise specified, the configured parameters can be configured via radio resource control (RRC) signaling per SL resource pool or per resource block (RB) set within a bandwidth part (BWP).

### Embodiment D-1: Frequency Resource Structure in SL Communication

An RB set is the bandwidth of a sub-band for shared spectrum channel access, including a set of RBs within an approximately 20 MHz segment of the channel. An RB set includes one or more than one subchannel, RB-based interlace, or RB-based contiguous resource. A subchannel corresponds to one or more than one RB-based interlace or one or more than one RB-based contiguous resource. An SL resource pool includes one or more than one RB sets. A BWP includes one or more than one SL resource pool.

### Embodiment D-2: SL Resource Pool Related Configurations

SL resource pool related configurations may comprise one or more of:
1. Size of an SL resource pool;
2. Number of SL resource pools;
3. Location of SL resource pool; and
4. Resource structure of an SL resource pool.

SL resource pool related configurations are detailed in the following.

### 1. Size of an SL Resource Pool:

The size of an SL resource pool can be indicated based on a number of RB sets or a number of subchannels. A subchannel can include one or more than one RB. One or more than one subchannels can be included in an RB set.

The size of an SL resource pool for SL transmission (referred to as a transmission SL resource pool) and an SL resource pool for SL reception (referred to as a reception SL resource pool) can be configured independently for a UE (e.g., UE 10a or UE 10b).

### 2. Number of SL Resource Pools:

The number of transmission SL resource pools and the number of reception SL resource pools within a BWP can be configured independently for a UE (e.g., UE 10a or UE 10b).

### 3. Location of SL Resource Pool:

In the frequency domain: One or more than one RB set within a SL resource pool can be configured by gNB and indicated based on at least one of following schemes:
An initial index of RB set and the number of contiguous SL RB sets.
A per RB set bitmap, each bit indicating one RB set. The length of the bitmap can be configured by gNB.
A row index indicated to represent one or more than one RB set according to a mapping table pre-configured by gNB.

In the time domain: The location of an SL resource pool may comprise periodically occurred slot locations for SL transmission in an SL resource pool. The periodically occurred slot locations can be indicated based on at least one of the following configurations:
A periodicity of the SL resource pool; or
the slot locations of the SL resource pool.

The slot locations of the SL resource pool can be indicated based on at least one of the following schemes:
A location of an initial slot and a number of contiguous slots;
A slot-based bitmap, each bit indicates one slot, where the length of the bitmap can be configured by gNB; or
A row index in a mapping table, which indicates one or more than one slot according to the mapping table pre-configured by gNB.

### 4. Resource Structure of an SL Resource Pool:

The resource structure of an SL resource pool may comprise a RB-based interlace resource structure or a RB-based contiguous resource structure.

If an SL resource pool is constituted by multiple RB sets, the entirety or a portion of the RB sets may be configured for RB-based interlace resource structure, and the remaining RB sets may be configured for RB-based contiguous resource structure. The location and number of RB sets that constitutes an RB-based interlace resource region or an RB-based contiguous resource region can be configured by gNB.

A subchannel defined in NR-V2X can include one or more than one RB-based interlaces or one or more than one group of contiguous RBs.

For RB-based interlace resource, one or more instances of the following information may be provided by gNB to indicate the structure:
A number of interlaces, an RB interval of an interlace, or a number of RBs in a interlace, each subject to configured subcarrier spacing (SCS).
An index for an interlace or a group of interlaces as may be used in an indexing scheme. The index may comprise an initial interlace index accompanied with the number of consecutive interlaces.
A range of indexed interlaces.

Note that if an SL resource pool is constituted by more than one RB set, an interlace can be applied across adjacent RB sets. That is, each of RB set guard(s) band can be adopted as part of an SL resource pool.

For RB-based contiguous resource structure, one or more instances of the following information may be provided by gNB to indicate the structure:
A number of contiguous RBs as an RB group.
An index for an RB group or more than one RB group as may be used in an indexing scheme. The index may comprise an initial RB group index accompanied with the the number of consecutive RB groups.

Note that if an SL resource pool is constituted by more than one RB set, an interlace can be applied across adjacent RB sets. That is, each of RB set guard(s) band can be adopted as part of an SL resource pool.

### Embodiment D-3: SL Control-Resource Set (CORESET) or PSSCH Configurations

The configurations may include resource configuration and resource structure of a CORESET that carries PSSCH(s) or a resource set that carries PSSCH(s).

### 1. Resource Configuration of a CORESET or a Resource Set Carrying PSSCH(s):

A gNB may configure one or more than one CORESET in an SL resource pool.

A gNB can configure one or more than one RB set in an SL resource pool constituting a CORESET. The gNB may use a per RB set bitmap to indicate the one or more than one RB set constituting a CORESET within a SL resource pool, wherein each bit in the bitmap corresponds to an RB set. The gNB can further configure one or more than one subchannel, interlace, or RB group in an RB set constituting a CORESET. Alternatively, a UE can blindly detect a CORESET within an RB set.

A gNB can configure a number of contiguous PSCCH symbols in a slot for a CORESET.

A gNB can configure a search space indication for monitoring a CORESET. The gNB can be configure a search space based on a slot format, such as slot-based, mini-slot based (shorter slot length with less OFDM symbols or higher SCS), or sub-slot based (additional or different PSCCH location within a slot) format, for a UE. The gNB can separately configure for a UE two sets of search space indications, defined per SL resource pools or per RB sets. Each of the two sets of search space indications include slot format, monitoring period, monitoring offset, and/or first stage SCI format. The UE monitor a PSCCH within a COT and out of a COT according to the two sets of search space indications.

A common CORESET or a common search space can be configured on overlapped RB set(s) which is commonly used for UEs with different numbers or locations of RB sets, different numbers or locations SL resource pools, or different sizes or locations of SL resource pools.

At least a portion of the content of a CORESET carrying PSCCH(s) in an RB set can be duplicated to other RB set(s) to be received by Rx UEs with different numbers or locations of RB sets, different numbers or locations SL resource pools, or different sizes or locations of SL resource pools.

Two sets of CORESET sizes and/or locations can be separately configured for a UE that monitors a PSCCH within a COT and out of a COT.

The size of a PSCCH carrying the first stage SCI can be the same for unicast, groupcast or broadcast transmissions per SL resource pool or per RB set.

### 2. Resource Structure of a CORESET or a Resource Set Carrying PSCCH(s):

A CORESET resource for carrying PSCCH(s) can be deployed based on RB-based interlace resources or RB-based contiguous resources.

1. For RB-based interlace resources. CORESET resources can be confined within an RB set. If more than one RB set is configured to carry a CORESET, at least one of the following schemes can be adopted.

Scheme 1: One or more than one interlace of a CORESET can be applied across more than one RB set. A CORESET can comprise one or more than one interlaces. Different CORESETs can belong to different interlaces.

Scheme 2: Interlaces of CORESET resources are confined within a reference RB set, and the same interlace structure of the CORESET in the reference RB set is copied to other RB set(s). A CORESET can comprise one or more than one interlaces. Different CORESETs can belong to different interlaces. Same interlace structure of a CORESET in the reference RB set is applied to other RB sets to increase PSSCH candidates.

Scheme 3: Different CORESETs belong to different RB sets. A CORESET resource includes one or more than one interlaces can only be confined within an RB set.

For RB-based interlace resource:
An initial slice index, number of slices, and/or bitmap indication can be applied to determine selected interlace(s) to constitute a CORESET, wherein each bit in the bitmap corresponds to one interlace or a group of interfaces.
An RB level offset, number of RBs, and/or bitmap indication can be applied to determine selected RBs to constitute a CORESET within an interlace, wherein each bit in the bitmap corresponds to one RB.

2. For RB-based contiguous resource (RB group), a CORESET resource can be confined within an RB set. If more than one RB set is configured to carry a CORESET, at least one of the following schemes can be adopted.

Scheme 1: A CORESET resource includes one or more than one RB group, and the CORESET resource can be deployed across RB sets.

Scheme 2: One or more than one RB group of CORESET resource is confined within a reference RB set and the same CORESET resource structure in the reference RB set is copied to other RB set(s).
A CORESET can comprise one or more than one RB group.
Different CORESETs can belong to different RB groups in an RB set.
The same CORESET resource structure in a reference RB set can be applied to other RB sets to increase PSSCH candidates.

Scheme 3: Different CORESETs belong to different RB sets.

A CORESET resource includes one or more than one RB group can only be confined within an RB set.

3. For RB-based contiguous resource (RB group):
An RB level offset, a number of RB groups, and/or a bitmap indication can be used to determine selected RB group(s) that constitute a CORESET, where in each bit in the bitmap corresponds to one RB group.
An RB level offset, a number of RBs, and/or a bitmap indication can be applied to determine selected RBs to constitute a CORESET within an RB group, wherein each bit in the bitmap corresponds to one RB.

### Embodiment D-4: PSFCH Resource Configurations

PSFCH resource configurations comprises time domain location and frequency domain location of PSFCH resources.

### Time Domain Location of PSFCH Resources:

Preconfigured PSFCH resource and/or dynamically indicated PSFCH resource can be defined per SL resource pool or per RB set.

For pre-configured PSFCH resource, the location of a PSFCH slot is determined based on at least one of the following schemes:

### Periodically Occurred PSFCH Resource:

For periodically occurred PSFCH resource, the location of a slot including a PSFCH resource is determined based at least one of the following parameters:
Periodicity of PSFCH resource in slot granularity.
An offset of PSFCH period in slot granularity. A slot level offset can be determined with respect to:
   A starting slot of a COT,
   the first slot carrying PSCCH, or
   the first symbol carrying PSCCH.
One or more than one slot location carrying a PSFCH resource within a period.
   A bitmap indication can be adopted to determine selected slot(s) carrying PSFCH resource(s) within period, wherein each bit in the bitmap corresponds to one slot.
One or more than one symbol location carrying a PSFCH resource within a slot.
   A bitmap indication can be adopted to determine selected symbol(s) carrying PSFCH resource(s) within a slot, wherein each bit in the bitmap corresponds to one symbol.

For periodically occurred PSFCH resource, a minimum PSSCH-to-PSFCH feedback timing, i.e., a minimum number of slots between a slot with a PSSCH transmission and a PSFCH slot with a corresponding HARQ feedback of the PSSCH transmission, can be pre-configured by gNB for an SL resource pool or an RB set. A UE (e.g., UE 10a or UE 10b) can determine the PSFCH slot location based on the earliest slot carrying PSFCH resource while taking minimum PSSCH-to-PSFCH feedback timing into account. For example, the earliest slot is determined as the first available PSFCH slot for HARQ feedback.

If the location of any PSFCH slot determined by the above-described schemes is not within the COT carrying the scheduled PSSCH, the PSFCH retransmission or deferral scheme in Embodiment C can be adopted.

### Dynamically Indicated PSFCH Resource:

For dynamically indicated PSFCH resource, a slot location is determined based on one or more than one predefined PSCCH-to-PSFCH timings.

PSCCH-to-PSFCH timing is a slot offset between the slot carrying a PSCCH and the slot carrying PSFCH for an HARQ feedback of a corresponding PSSCH.

If there are multiple slots carrying PSCCH within a COT:
Each SCI carried in different PSCCH slots can point to the same PSFCH slot location using different PSCCH-to-PSFCH timings, or
PSCCH-to-PSFCH timing for determining the PSFCH slot location can be determined or overwritten by the SCI carried in the last PSCCH slot.

A set of PSCCH-to-PSFCH timings can be configured by gNB per SL resource pool or per RB set. One or more than one PSFCH slot occasion can be dynamically indicated in the first stage SCI or the second stage SCI based on available PSCCH-to-PSFCH timing(s) in the PSCCH-to-PSFCH timing set.

For dynamically indicated PSFCH resource, slot location is determined based on one or more than one predefined PSSCH-to-PSFCH timing.

PSSCH-to-PSFCH timing is a slot offset between the ending slot carrying PSSCH and the slot carrying PSFCH for the corresponding HARQ feedback of the PSSCH.

If there are multiple slots carrying PSSCHs due to PSSCH repetition or scheduling of multiple-PSSCH-slots within a COT, then the last PSSCH slot may be used as a time reference of PSSCH slot.

A set of PSSCH-to-PSFCH timings (referred to as PSSCH-to-PSFCH timing set) can be configured by gNB per SL resource pool or per RB set.

One or more than one PSFCH slot occasion can be dynamically indicated in the first or second stage SCI based on available PSSCH-to-PSFCH timing(s) in the PSSCH-to-PSFCH timing set.

For dynamically indicated PSFCH resource, more than one slot location with PSFCH resource can be determined based on a PSSCH-to-PSFCH timing or a PSCCH-to-PSFCH timing and a number of PSFCH transmission occasions following the slot location indicated by the PSSCH-to-PSFCH timing or the PSCCH-to-PSFCH timing.

For dynamically indicated PSFCH resource, one or more than one PSFCH resource of a PSFCH symbol or one or more than one PSFCH symbol location within a slot can be pre-configured by a gNB.

For dynamically indicated PSFCH resource, if the location of PSFCH slot determined by above schemes is not within the COT carrying the scheduled PSSCH, then the PSFCH dropping. PSFCH retransmission or deferral scheme in Embodiment C can be adopted.

### Frequency Domain Location of PSFCH Resources:

A gNB can configure one or more than one RB sets in a SL resource pool that includes PSFCH resources.

Indication of one or more than one RB set that carries PSFCH resources within a SL resource pool can be based on a per RB set bitmap, wherein each bit in the bitmap corresponds to an RB set.

The gNB can further configure one or more than one subchannel, interlace, or RB group within an RB set that includes PSFCH resources.

PSFCH resources can be deployed based on RB-based interlace resources or RB-based contiguous resources.

For RB-based interlace resources, if a PSFCH resource includes one RB, i.e., similar to PUCCH format 0/1, the following applies. For an interlace includes multiple RBs, the following resource deployment can be adopted:

Scheme 1: A PSFCH resource is extended to all RBs in an interlace by applying the same sequence with same or different cyclic shifts to different RBs in an interlace. In this case, different interlaces corresponds to different PSFCH resources.

Scheme 2: A PSFCH resource is spread to all RBs in an interlace by multiplying an orthogonal cover code. In this case, more HARQ bits can be carried on an interlace or multiple HARQ feedbacks of different users can be multiplexed onto an interlace.

Scheme 3: Multiple PSFCH resources are multiplexed onto an interlace using a frequency division multiplexing (FDM). In this case, more HARQ bits can be carried on an interlace, or multiple HARQ feedbacks of different users can be multiplexed onto an interlace.

### For RB-Based Interlace Resources:

For RB-based interlace resources, if a PSFCH resource includes more than one RB, i.e., similar to PUCCH format 2/3, the following applies. For an interlace includes multiple RBs, the following resource deployment can be adopted:

Scheme 1: A PSFCH resource of more than one RB is extended to all RBs in an interlace through duplication. In this case, different interlaces corresponds to different PSFCH resources.

Scheme 2: A PSFCH resource of more than one RB is evenly distributed to all RBs in an interlace. If RB size of a PSFCH resource is larger than RB size of an interlace, more than one interlace can be selected. RB size means the number of RBs.

Scheme 3: Multiple PSFCH resources are multiplexed to an interlace using FDM. In this case, a PSFCH resource is locally distributed in an interlace, and more HARQ bits can be carried on an interlace, or multiple HARQ feedbacks of different users can be multiplexed onto an interlace.

Scheme 4: A PSFCH resource is spread to all RBs in an interlace by multiplying an orthogonal cover code. In this case, more HARQ bits can be carried on an interlace, or multiple HARQ feedbacks of different users can be multiplexed onto an interlace.

### For RB-Based Contiguous Resources:

For RB-based contiguous resources. PSFCH resources in an RB set used for HARQ feedback can be indicated based on at least one of following:

A gNB pre-configures location(s) of one or more than one RB which can be used for PSFCH transmission within an RB set based on a bitmap, wherein each bit of a bitmap corresponds to an RB.

The gNB pre-configures location(s) of one or more than one RB which can be used for PSFCH transmission within an RB set based on an RB initial index, an RB level offset, or a number of contiguous RBs.

If a PSFCH resource includes more than one RB, i.e., like PUCCH format 2/3, an RB-group-based index can be adopted.

PSFCH and PSCCH can be FDM multiplexed in an RB set using RB-based interlace resources or RB-based contiguous resources.

in an embodiment, such as embodiment D-4, the multiple resource locations of sidelink feedback channel correspond to slot locations or symbol locations, and the multiple resource locations of sidelink feedback channel are preconfigured per RB set or per sidelink resource pool. The multiple resource locations of sidelink feedback channel correspond to one or more than one RB set index or one or more than one RB-based interlace. The multiple resource locations of sidelink feedback channel may be preconfigured per RB set or per sidelink resource pool.

With reference to FIG. 2, in an embodiment, such as embodiment D-4, the multiple resource locations of sidelink feedback channel are determined based on a minimum PSSCH-to-PSFCH feedback offset, wherein the minimum PSSCH-to-PSFCH feedback offset is a relative time offset between the ending time of the sidelink data channel and the staring time of the sidelink feedback channel.

With reference to FIG. 2, in an embodiment, such as embodiment D-4, resource in each of the multiple resource locations of sidelink feedback channel are an RB-based interlace resource.

### Embodiment D-5: PSFCH Resource Determination

The location of PSFCH resource can periodically occur and pre-configured per SL resource pool or per RB set via RRC configuration by the gNB or dynamically indicated by the gNB via DCI or by Tx UE via SCI. A gNB, Tx UE, or a Rx UE determines an SL resource pool or an RB set used for PSFCH transmission.

### Determination of an SL Resource Pool or an RB Set Used for PSFCH Transmission:

For a PSFCH resource is transmitted within an SL resource pool/an RB set, implicit or explicit indication of an SL resource pool/an RB set carrying a PSFCH can be applied based on at least one of the following:
The SL resource pool/RB set carrying a PSFCH is implicitly determined based on the location of the SL resource pool/RB set carrying a PSCCH scheduling a PSSCH.
The SL resource pool/RB set carrying a PSFCH is implicitly determined based on the location of the SL resource pool/RB set carrying the scheduled PSSCH with corresponding HARQ feedback on the PSFCH.
The SL resource pool/RB set carrying a PSFCH is explicitly indicated by the first stage SCI on the PSCCH or the second stage SCI on the PSSCH.

### PSFCH Resource Structure:

A PSFCH resource structure may be realized and indicated as detailed in the following.

A PSFCH resource is associated with a time domain resource (PSFCH symbol), a frequency domain resource (one or more than one RB), and a code domain resource (cyclic shift pair).

Depending on the PSFCH format (similar to PUCCH format 0/1/2/3), one or more than one RB can be used for a PSFCH resource before interlacing, and one or more than one consecutive PSFCH symbol can be used for PSFCH transmission.

Depending on the number of UEs for multiplexed HARQ feedbacks, the following parameters can be assigned for adjusting the number of PSFCH resources.
The number of cyclic shift pairs.
The number of RBs of an RB set in a PSFCH symbol assigned for carrying PSFCH resources before interlacing.

Determination of the location of one or more than one PSFCH resource with respect to a PSSCH resource can be based on PSSCH-to-PSFCH resource mapping or a dynamic PSSCH-to-PSFCH resource indication. A gNB, Tx UE, or a Rx UE determines the location of one or more than one PSFCH resource.

### PSSCH-to-PSFCH Resource Mapping in an RB Set:

A PSSCH resource corresponds to one or more PSSCH interlaces within a slot, or a PSSCH resource corresponds to one or more PSSCH RB groups (contiguous RBs or subchannels) within a slot.

A PSFCH resource corresponds to one cyclic shift pair of one RB (PSFCH format 0/1) or multiple RBs (PSFCH format 2/3) before RB-based interlacing.

A base sequence of a Zadoff Chu sequence used for PSFCH in PSFCH format 0/1 can be pre-configured by gNB.

A PSSCH resource with one or more than one PSSCH interlace can map to a set of RBs used for PSFCH resource before interlacing or RBs in a PSFCH interlace after interlacing. At least one of the following mapping schemes can be applied:
If a PSSCH resource includes one interlace, each interlace can map to a set of RBs carrying PSFCH resources.
If a PSSCH resource includes more than one PSSCH interlace, each of the more than one PSSCH interface can map to a set of RBs carrying PSFCH resources, or the PSSCH interlace with lowest index is mapped to a set of RBs carrying PSFCH resources.
Different PSSCH interlaces in the same slot map to different sets of RBs carrying PSFCH resources in the same slot

An Rx UE selects a PSFCH resource index among a plurality of available PSFCH resources in a PSFCH symbol for an HARQ feedback of a PSSCH within an RB set. The Rx UE can determine PSFCH resource index based on a function of at least one of the following parameters:
The slot location(s) of the received PSSCH.For multi-slot scheduling of a TB, one of slot locations, e.g., the last slot, scheduled for transmission of a PSSCH can be used as a reference slot to determine a PSFCH resource.
An interlace index of the received PSSCH.
The number of interlaces in an RB set for PSSCH transmission.
The number of interlaces per received PSSCH resource.
Tx UE ID or Rx UE ID.
The number of cyclic shift pairs.
The number of RBs within an RB set carrying PSFCH resource in a PSFCH symbol.
The number of Rx UEs in a SL group-cast communication.
The number of Rx UEs receiving unicast SL communications in the same slot.

### Dynamic PSSCH-to-PSFCH Resource Indication:

A set of PSFCH resources in the frequency domain can be pre-configured for an RB set via RRC signaling by gNB.
One of PSFCH resources may be indicated in the first stage SCI in PSCCH or the second stage SCI in PSSCH by the Tx UE.
The Rx UE determines the PSFCH resource based on the received PSFCH resource indication.

With reference to FIG. 2, in an embodiment, such as embodiment D-5, at least one parameter relevant to the multiple resource locations of sidelink feedback channel associated with the sidelink data channel is pre-configured. The at least one parameter may comprise a maximum number of the multiple resource locations of sidelink feedback channel associated with the sidelink data channel. The at least one parameter may comprise information indicating whether the multiple resource locations of sidelink feedback channel associated with the sidelink data channel are supported.

With reference to FIG. 2, in an embodiment, such as embodiment D-5, the multiple resource locations of sidelink feedback channel are within the same RB set. The multiple resource locations of sidelink feedback channel and a resource location of the sidelink data channel are within the same RB set.

With reference to FIG. 2, in an embodiment, such as embodiment D-5, the multiple resource locations of sidelink feedback channel are determined based on a resource location of the sidelink data channel. At least one of the multiple resource locations of sidelink feedback channel are dynamically indicated in the sidelink control information. In an embodiment, such as embodiment D-5, an index of an RB set including the multiple resource locations of sidelink feedback channel are dynamically indicated in the sidelink control information.

### Embodiment D-6: HARQ Feedback Scheme Configurations

To improve feedback efficiency, at least one of the following configurations can be provided by gNB per SL resource pool or per RB set.
Codebook based HARQ feedback, i.e., Type 1/(enhance) Type 2/(enhanced) Type 3 codebook. HARQ feedbacks of multiple PSSCHs can be transmitted in the same PSFCH resource using a codebook.
Additional PSFCH format(s) for supporting more HARQ feedbacks or supporting more reliable transmission for greater transmission distance (known as coverage), e.g., more RBs in a PSFCH resource before interlacing or more PSFCH symbols in a slot for carrying HARQ feedback.
Using orthogonal cover code (OCC) to support more multi-UE multiplexed HARQ feedback.
Support of HARQ feedback deferral or HARQ feedback retransmission configured individually for unicast feedback when the HARQ feedback is transmitted from a single Rx UE or group-cast feedback when the HARQ feedbacks are transmitted from a group of Rx UEs.

To improve feedback reliability: at least one of the following configurations can be provided by gNB per SL resource pool.

A PSSCH resource or a PSSCH interlace can be mapped to multiple PSFCH resources. The location of mapped PSFCH resources can be deployed in at least one of the following schemes:
Each of the mapped PSFCH resources can belong to different RB sets.
   A common RB set for carrying PSFCH can be configured by gNB at overlapped RB set(s) which is commonly used for UEs with different numbers or locations of RB sets, different numbers or locations SL resource pools, or different sizes or locations of SL resource pools.
   The RB set used for PSFCH transmission can be indicated by the Tx UE in the first stage SCI in a PSCCH or a second stage SCI in a PSCCH.
Each of the mapped PSFCH resources can belong to different slots.
   With multiple PSFCH resources, the PSFCH can be transmitted repeatedly, i.e., PSFCH repetitions, or the PSFCH can be transmitted in at least one of multiple PSFCH transmission occasions (opportunities) over different slots, which can prevent loss of PSFCH transmission due to LBT failure.
   The gNB can configure a maximum number of multiple transmission occasions for an HARQ feedback.
A maximum number of HARQ feedback retransmissions per TB. The maximum number of retransmissions per TB can be configured individually for unicast or group-cast SL communication.

For an Rx UE to support a feedback type in an SL resource pool or an RB set, at least one of the following feedback types and corresponding parameters can be configured by a gNB or a Tx UE per SL resource pool or per RB set:
Parameters used to activate HARQ feedback function, deactivate HARQ feedback function, or support of multiple transmission occasions (opportunities) of an HARQ feedback. The parameters can be determined based on one or more of the following:
   configuration of location or periodicity of available PSFCH resources.
   configuration of the maximum number of multiple transmission occasions for an HARQ feedback.
An HARQ feedback type (e.g., NACK only or ACK/NACK feedback) for a groupcast SL transmission. Additional configurations can be configured by the gNB.
   The number of geographical zones for NACK only feedback in an SL resource pool or an RB set. Each zone corresponds to a region wherein a UE is located.
   The number of UE IDs within a group of a groupcast SL transmission in an SL resource pool or an RB set.
Blind feedback configuration for unicast, groupcast, or broadcast SL transmissions.
A maximum number of HARQ feedback retransmissions.
   If the scheduled resource for an HARQ feedback retransmission is outside of a COT in which a SCI scheduling the retransmission is transmitted, the retransmission can be dropped or deferred to a later initiated COT.
Codebook based or non-codebook based feedback.
   One or more than one codebook type can be configured for codebook based feedback.
PSFCH format.
   According to the required RB size or PSFCH symbol number, one or more than one PSFCH format can be configured for a PSFCH resource in a SL resource pool or an RB set.

### Embodiment D-7: Channel Access Relevant Configurations

### COT Duration Information:

The length of COT durations can be pre-configured by gNB using a lookup table and provided to UE (e.g., UE 10a or UE 10b) via RRC.

A Tx UE that has initiated a COT can indicate one of the COT durations based on a row index that refers to a row of the lookup table. The information of the indicated COT duration can be transmitted in the 1^{st} stage SCI.

The starting time of the COT can be the starting time of a slot/sub-slot or the first OFDM symbol carrying the information of COT duration.

### COT Frequency Resource Indication:

A Tx UE that has initiated a COT can indicate one of the interlaces, subchannels or RB sets which can be shared to a UE (e.g., UE 10a or UE 10b). The indicated one of the interlaces, subchannels, or RB sets may be pre-configured by a gNB. Indication of frequency resource for a COT can be based on one or more of the following:
A row index indication to the lookup table: and
An index of an interlace, subchannel or RB set.

### Multi-Channel Access or Multi-RB Set Access:

The Tx UE or Rx UE may support multi-channel access or multi-RB set access per SL resource pool. The gNB may configure for a Tx UE or a Rx UE as to whether the UE supports multi-channel access or multi-RB set access per SL resource pool. The gNB may configure approaches for accessing multi-channel. Approaches for accessing multi-channel may include:
Successful Type 1 LBT channel access procedure for each of channels before simultaneous multi-channel transmission.
Successful Type 1 LBT channel access procedure on one of channels and perform clear channel assessment (CCA) on each of channels before simultaneous multi-channel transmission.
   Channel Access Priority and/or Channel Access Scheme:

The gNB may configure, for UE, channel access priority and/or channel access scheme of SL transmissions per SL resource pool or an RB set.

The gNB may configure applicable CAPCs for each SL channel or SL signal, including PSCCH, PSSCH, PSFCH, S-SSB, for channel access out of a COT. The S-SSB stands for sidelink synchronization signal block.

The gNB may configure applicable LBT schemes, e.g., Type 1/2A/2B/2C and corresponding CPE length, for each of SL channels or SL signals, including PSCCH, PSSCH, PSFCH, S-SSB, for channel access within a COT.

The gNB may configure support of LBE-based channel access and/or FBE-based channel access for UE.

### Channel Sensing:

The gNB may configure a sensing window size, a sensing starting point, or the required time for completing a sensing procedure. The parameters of the sensing window size, the sensing starting point, or the required time can be configured differently depending on the CAPC of an SL channel or a SL signal.

A RSRP threshold in an SL resource pool or an RB set can be configured differently depending on the CAPC of an SL channel or SL signal for determining available resources in the sensing window.

A priority threshold in an SL resource pool or an RB set can be configured differently depending on the CAPC of an SL channel or SL signal for a preemption mechanism if configured by the gNB.

A UE (e.g., UE 10a or UE 10b) releases its reserved resource if it estimates in the first stage SCI that another UE with a priority higher than a priority threshold will use the same reserved resource.

### Embodiment D-8: Resource Scheduling Relevant Configurations

The gNB may configure resource scheduling relevant configurations for UE.

### MCS Table(s) Used for SL Transmission Per SL Resource Pool or an RB Set:

Resource scheduling relevant configurations for SL communication may comprise an MCS table configuration. The MCS table(s) can be separately defined for unicast and group-cast SL communication.

### Supported Transmission Types in an SL Resource Pool or an RB Set:

Resource scheduling relevant configurations for SL communication may comprise supported transmission types in an SL resource pool or an RB set. The transmission types can be categorized according to configured grant (CG) resource allocation, cast type of SL communication, and/or resource allocation mode. Some examples are detailed in the following:

CG resource allocation comprises Type 1 CG and/or Type 2 CG resource allocation with corresponding parameters for one or more CG configurations. Different CG configurations with different offsets or periodicities can be configured to different RB sets.

Cast type of SL communication comprises unicast, groupcast, and/or broadcast SL transmissions. Each RB set can be configured with different SL transmission schemes (i.e., cast type).

The resource allocation mode indicates support of Mode 1 and/or Mode 2 of resource allocation mode and corresponding parameters per SL resource pool or per RB set.

### For Mode 2 Resource Allocation:

The Tx UE executes Mode 2 resource allocation. The Mode 2 resource allocation can be realized by dynamic scheduling for single TB and/or semi-persistent scheduling (SPS) for multiple TB. Configuration of the Mode 2 resource allocation can include a configuration that indicates dynamic scheduling for single TB or semi-persistent scheduling (SPS) for multiple TB. Configuration of SPS for multiple TB may include configuration of a list of available resource reservation interval (RRIs) and corresponding reselection counter for semi-persistent scheduling.

If at least a portion of the slots of a semi-persistent scheduling cannot be confined within a COT used for scheduling the semi-persistent transmission, at least one of following schemes can be adopted:
Scheme 1: The slot(s) scheduled outside of the COT can be dropped.
Scheme 2: The slot(s) scheduled outside of the COT can be deferred or resumed for transmission after successful channel access in a later initiated COT.

The resource scheduling relevant configuration comprises a configuration to enable/disable of UE coordinated scheduling in Mode 2 resource allocation.

For contiguous multi-slot scheduling of a single TB (PSSCH repetition) or different TBs in Mode 1 or Mode 2 resource allocation, the resource scheduling relevant configuration comprises:
Configuration of a maximum number of slots or options (e.g., a list) of numbers of slots that can be selected for multi-slot scheduling.
Configuration of a maximum number of TBs for multi-slot scheduling.

Note that if a portion of the slots of a multi-slot scheduling cannot be confined within a COT scheduling a multi-slot transmission, then at least one of the following procedures can be adopted:
Scheme 1: The slot(s) scheduled outside of the COT can be dropped.
Scheme 2: The slot(s) scheduled outside of the COT can be deferred and resumed for transmission after successful channel access in a later initiated COT.

### Embodiment D-9: SL Slot Structure Relevant Configurations

The gNB can configure configuration of SL slot structure and numerology.

Configuration of SL slot structure is referred to as SL slot structure configuration. The following slot structure or slot feature can be pre-configured by gNB or Tx UE per SL resource pool or per RB set:
Support of a slot format, such as mini-slot, sub-slot, or a slot, within a COT or out of COT for performing channel access within a slot or at a slot boundary.
Support of single slot scheduling and/or contiguous multi-slot scheduling within a COT.
Available symbol locations within a slot applicable for SL transmission, the available SL symbols per slot can be indicated with a starting symbol and a number of consecutive symbols.
An indication of flexible guard symbol at the end of a slot due to contiguous multi-slot scheduling.
Applicable DMRS patterns or DMRS locations for PSSCH within a slot. DMRS pattern for PSSCH scheduling can be indicated by a first stage SCI in the PSCCH. A DMRS sequence initial value is pre-configured for a SL resource pool or an RB set.

### Numerology Information

Configuration of SCS or CP by a gNB or a Tx UE can be applied to an SL resource pool or an RB set.

### Embodiment D-10: S-SSB Relevant Configurations

S-SSB configuration comprises configuration or S-SSB resource, such as the location, occasion, quasi-co-location (QCL) relationship, and/or multiplexing scheme of S-SSB resources. For example, the S-SSB configuration comprises:
A number of S-SSB occasions within a period and the periodicity of S-SSB occasions.
Locations of S-SSB occasions within a period and the periodicity of S-SSB occasions.
Intra-period or inter-period QCL relationship for different S-SSBs
A TDM or FDM multiplexing scheme between S-SSB and CORESET or between S-SSB and PSCCH.
A TDM or FDM multiplexing scheme between S-SSB and PSSCH. TDM stands for time division multiplex (TDM).

### Embodiment E

In Mode 1 or Mode 2 resource allocation, for a Tx UE that schedules consecutive multi-slot SL transmissions of one or more than one TB to one or more than one Rx UE, at least one of the following information can be provided as an indication by a gNB to a Tx UE via RRC message or DCI in Mode 1 resource allocation or can be determined as an indication by a Tx UE in Mode 2 resource allocation. The indication of resource allocation can be provided to a Rx UE.

### Embodiment E-1: Frequency Domain Resource Allocation

TBs may include initial PSSCH transmission or PSSCH retransmission(s). One or more instances of the following information may be used to indicate the frequency domain resource location(s) of each of the TBs.
SL bandwidth part (BWP) index.
Index of transmission SL resource pool within an SL BWP.
One or more than one SL RB set within a SL resource pool.
   For multiple channel access, more than one RB sets are assigned for a UE (e.g., UE 10a or UE 10b).
One or more than one subchannel within an RB set for a PSCCH (re)transmission.
   In some embodiments, a subchannel in the indication can be replaced by an RB-based interlace or an RB-based contiguous RB group.
   For multiple subchannels, the group of subchannels can be indicated based on an initial index of a subchannel and a number of contiguous subchannels, based on a per subchannel bitmap, or based on an indication index to subchannels in a mapping table configured by gNB.
PSCCH location in at least one of subchannels.

The same frequency domain resource can be applied to at least one of the TBs for consecutive multi-slot transmission.

### Embodiment E-2: Time Domain Resource Allocation

TBs may include initial PSSCH transmission or PSSCH retransmission(s). One or more instances of the following information may be used to indicate the time domain resource location(s) of each of the TBs:
Time domain resource locations for each of the TBs.

Indication of consecutive slots for multiple PSSCH transmissions can be based on one of following schemes.
The group of consecutive slots can be indicated using an offset value of the first slot and a number of consecutive slots, wherein the offset value is with respect to the slot carrying DCI and each slot corresponds to one TB.
The group of consecutive slots can be indicated using a bitmap as an indication within a scheduling period, wherein each bit corresponds to one slot location of a slot.
The group of consecutive slots can be indicated using a row index that refers to a row of a mapping table configured by gNB, wherein each row index of the mapping table indicates slot locations of multiple consecutive slots.

Non-slot based Type B resource mapping (mini-slot with a length ranging from 2 to 13 symbols) can be scheduled for multi-slot transmissions.

The slot locations of one or more retransmissions of an TB can be indicated using one of the following:
An indication of a slot offset relative to the slot carrying the initial transmission of the TB.
A resource indication value (RIV) parameter that indicates one or more than one slot within a time window.
DCI dynamically indicated by a gNB.

The location of PSSCH symbols in each slot can be indicated using a start symbol and a number of consecutive symbols, i.e., start and length indicator values (SLIVs). A mapping table is configured with at least one row mapped to multiple SLIVs, wherein each SLIV corresponds to one of scheduled multiple slots.

A common repetition pattern or separated repetition patterns can be configured for multiple TBs. For the time domain resource location allocated for multi-slot transmission with repetitions, the following repetition configurations can be adopted.

### Common Repetition Pattern for Multiple TBs:

A time domain resource allocation (TDRA) table can be used to configure for multiple TBs where the multiple TBs share the same repetition patterns. The following schemes may be used to configure the common repetition patterns.

Scheme 1: The UE (e.g., UE 10a or UE 10b) transmits the multiple TBs as a first group and one or more group repetitions of the first group following the first group.

The row of an indexed SLIV in the TDRA table indicates the location of the first TB, and the locations of other TBs are orderly arranged sequentially following the first TB. After all the TBs have been transmitted, the group of TBs are repeatedly transmitted as the group repetitions until a specified repetition number of group repetitions is reached.

Scheme 2: The UE (e.g., UE 10a or UE 10b) transmits repetitions of the first TB and then followed by repetitions of a next TB:

The row of an indexed SLIV in the TDRA table indicates the location of the first TB, and transmission of repetitions of the first TB is conducted firstly according to a repetition number, followed by the next TB. The location of the next TB can be implicitly determined based on the location of previous TB(s) and the repetition number.

### Independent Repetition Patterns for Multiple TBs:

The TDRA table can be extended or enhanced to accommodate more than one set of SLIVs and repetition numbers in a row.

The UE (e.g., UE 10a or UE 10b) uses a row index in RRC signaling or DCI to select a set of SLIVs and repetition numbers for mapping to multiple TBs. The SLIV and repetition number can be independently indicated for each TB.

### Embodiment E-3: Flexible Guard Symbol Indication

The presence of a guard symbol in a slot can be indicated explicitly or implicitly in the first stage SCI of the first slot that carries a PSCCH.

Insertion of a guard symbol into a slot can be determined based on one of the following schemes.

A guard symbol in each slot can be implicitly determined based on a SLIV corresponding to the slot.

For example, a guard symbol is inserted at the end (i.e., the last symbol) of a slot if the last symbol of the slot is not selected for PSSCH transmission as indicated by the corresponding SLIV. Otherwise, the guard symbol is not inserted into the slot, and the PSSCH is rate matched until the last symbol of the slot.

For example, if a PSFCH symbol and a corresponding automatic gain control (AGC) symbol or a guard symbol are present in a slot, at least one of these three symbols is not included in the range of the SLIV. Otherwise. these three symbols can be used for PSSCH transmission according to a SLIV that includes all these three symbols.

An additional column may be added to the resource mapping table for the gap location indication, or a row index may be used to indicate a guard symbol location of the corresponding slot.

The guard symbol insertion can be implicitly determined. Only the ending symbol of the final slot in multi-slot scheduling is a guard symbol.

The guard symbol insertion can be implicitly determined based on the CPE duration indicated by extending CP of the symbol next to the guard symbol. If the CPE is not applied, a guard symbol is inserted.

A guard symbol and/or an AGC symbol after the guard symbol in a slot can be reused for PSSCH transmission if the guard symbol is not present. A guard symbol can be reused for PSSCH transmission if the guard symbol is not present. An AGC symbol at the first symbol of an SL slot can be reused for PSSCH transmission if the guard symbol at the end of the previous SL slot is not indicated. An AGC symbol after a guard symbol for PSFCH transmission in a slot can be reused for PSSCH transmission if presence of the guard symbol at the end of the previous SL slot is not indicated, or if the location of the PSFCH symbol used for PSFCH transmission does not exist, wherein the location of PSFCH symbol is dynamically indicated.

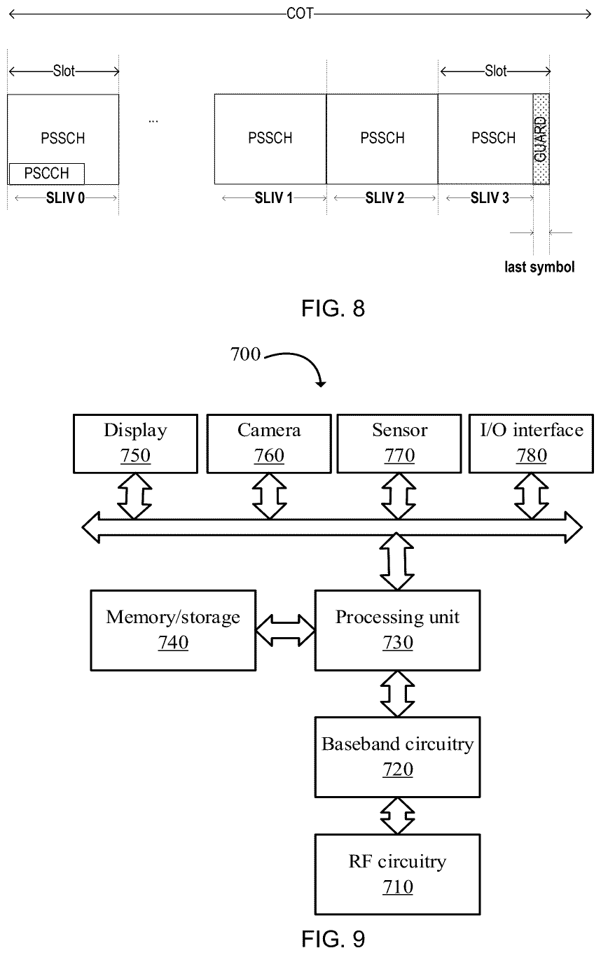

FIG. 8 shows an example using SLIV as an implicit indication to indicate whether the last symbol of an SL slot is used as a guard period (i.e., a guard symbol). If the range of an SLIV value does not cover the last symbol, i.e., SLIV 3, then the last symbol is used as a guard period (i.e., a guard symbol).

### Embodiment E-5: MCS and HARQ Process ID, NDI and RV Indication for Each TB

For consecutive multi-slot scheduling for multiple PSSCHs with different TBs, one or more of the following parameters and configuration schemes can be configured and used for each of the TBs.
MCS can be the same for each TBs.
Only the first HARQ process ID of the first TB is indicated. Other HARQ process ID can be derived from the first HARQ process ID.
Individual NDI and RV indication for each of the HARQ process ID.

### Embodiment E-6: HARQ Feedback Location Indication for Each TB

Slot location(s) for HARQ feedback for each of the TBs can be determined based on one of the following schemes. A slot for HARQ feedback in response to a TB may be referred to as a feedback slot.
The feedback slot can be indicated using a slot offset value relative to the last slot of the multi-slot scheduling. HARQ bits of the TBs are transmitted in the same slot.
If the slot carrying PSFCH resource for HARQ feedback is periodically configured, the feedback slot is the earliest slot carrying PSFCH that is determined based on the PSSCH-to-PSFCH feedback timing and the slot location of each scheduled PSSCH.
The PSFCH resource used for HARQ feedback is determined based on a PSSCH-to-PSFCH resource mapping with a fixed PSFCH period or can be dynamically indicated, e.g., as described in Embodiment D-4 and Embodiment D5.
If the location of a PSFCH slot for an HARQ feedback is out of the COT that carries the PSSCH associated with the HARQ feedback, the HARQ feedback should be dropped, deferred or re-transmitted on a later COT as described in Embodiment B.

### Embodiment F: Repetition or Blind Retransmission Behavior for an SL Transmission

Type B repetition can be supported for Mode 1 or Mode 2 resource allocation. If a nominal repetition of Type B repetition spans one or more invalid symbols, the nominal repetition can be skipped or can be segmented into one or more actual repetitions. For example, a nominal repetition is segmented into a first actual repetition located before invalid symbol(s) and a second actual repetition located after the invalid symbol(s).

Invalid symbol(s) includes at least one of the following:
A guard symbol at the end of a SL slot.
A guard symbol before the AGC symbol of PSFCH in a SL slot.
Any symbol of a slot configured not to be used for SL communication by gNB.

If a nominal repetition is segmented into one or more actual repetitions, a gap is created immediately due to one or more invalid symbols. The UE (e.g., UE 10a or UE 10b) may perform LBT during the gap before transmitting the actual repetition. The LBT type or channel access scheme for accessing the channel after invalid symbol(s) depends on one of the following:
The length of invalid symbol(s).
An LBT indication Indicated by a Tx UE.

If a nominal repetition of Type B repetition crosses a slot boundary, the nominal repetition can be skipped or can be segmented into one or more actual repetitions. For example, a nominal repetition is segmented into a first actual repetition located before the slot boundary and a second actual repetition located after the slot boundary.

If an orphan symbol is created due to segmentation, then one of the following transmission operations can be adopted:
The orphan symbol is not transmitted.
The orphan symbol is transmitted as a DMRS symbol.
The orphan symbol is transmitted in a way like an AGC symbol, i.e., as a copy of the next symbol in the same slot.
The orphan symbol is transmitted based on CPE of a subsequent symbol.

FIG. 9) is a block diagram of an example system 700 for wireless communication according to an embodiment of the present disclosure. Embodiments described herein may be implemented into the system using any suitably configured hardware and/or software. FIG. 9) illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting. etc. In some embodiments, the baseband circuitry may provide for communication compatible with one or more radio technologies. For example, in some embodiments, the baseband circuitry may support communication with 5G NR. LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency. which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for execution by a user equipment (UE), comprising:
performing channel occupancy time (COT) initiating for a COT based on a channel access scheme;
transmitting sidelink data and sidelink control information within the COT; and
receiving sidelink hybrid automatic repeat request (HARQ-ACK) feedback in response to the transmitted sidelink data within the COT;
wherein the sidelink HARQ-ACK feedback is transmitted in a resource block (RB) set, and resources available for receiving the sidelink HARQ-ACK feedback in an RB set are preconfigured.

2. The wireless communication method of claim 1, wherein the sidelink data is transmitted in a sidelink shared channel, and the sidelink HARQ-ACK feedback is received from a sidelink feedback channel, wherein the sidelink feedback channel is located on at least one resource occasion of multiple resource occasions for sidelink feedback channel transmission;
wherein each of the multiple resource occasions for sidelink feedback channel transmission is periodically occurred.

3. The wireless communication method of claim 2, wherein at least one parameter relevant to transmission opportunities on the multiple resource occasions for sidelink feedback channel is pre-configured.

4. The wireless communication method of claim 3, wherein the at least one parameter comprises a number of the multiple resource occasions for sidelink feedback channel transmission.

5. The wireless communication method of claim 3, wherein the at least one parameter comprises information indicating support of multiple resource occasions for sidelink feedback channel transmission.

6. The wireless communication method of claim 2, wherein a resource structure of the sidelink feedback channel is preconfigured.

7. The wireless communication method of claim 3, wherein the multiple resource occasions for sidelink feedback channel transmission correspond to more than one slot location, and a number of the more than one slot location are configured per sidelink resource pool.

8. The wireless communication method of claim 3, wherein the multiple resource occasions for sidelink feedback channel transmission correspond to more than one RB set, and each of the more than one RB set is preconfigured per sidelink resource pool.

9. The wireless communication method of claim 3, wherein the multiple resource occasions for sidelink feedback channel transmission are within the same RB set.

10. The wireless communication method of claim 3, wherein the multiple resource occasions for sidelink feedback channel transmission and an associated resource location for the sidelink shared channel transmission are within the same RB set.

11. The wireless communication method of claim 3, wherein the multiple resource occasions of sidelink feedback channel are determined based on a minimum PSSCH-to-PSFCH feedback offset, wherein the minimum PSSCH-to-PSFCH feedback offset is the minimum number of slots between the last slot carrying the sidelink shared channel and a slot carrying the sidelink feedback channel.

12. The wireless communication method of claim 3, wherein frequency domain resources of the multiple resource occasions for sidelink feedback channel are determined based on a resource location of the sidelink shared channel.

13-14. (canceled)

15. The wireless communication method of claim 6, wherein the resource structure in each of the multiple resource occasions of sidelink feedback channel is RB-based interlace resource, and the RB-based interlace resource is preconfigured per sidelink resource pool.

16. The wireless communication method of claim 1, wherein the sidelink control information includes an identity associated with a destination UE from which HARQ-ACK feedback is to be received in response to the transmitted sidelink data.

17-22. (canceled)

23. A wireless communication method for execution by a user equipment (UE), comprising:
receiving sidelink data and sidelink control information within a channel occupancy time (COT);
performing a channel access scheme; and
transmitting sidelink HARQ-ACK feedback information in response to the received sidelink data within the COT;
wherein the sidelink HARQ-ACK feedback is transmitted in an RB set, and resources available for transmitting the HARQ-ACK feedback in an RB set are preconfigured.

24. The wireless communication method of claim 23, wherein the sidelink data is received from a sidelink shared channel and the sidelink HARQ-ACK feedback is transmitted in a sidelink feedback channel, wherein the sidelink feedback channel is located on at least one resource occasion of multiple resource occasions for sidelink feedback channel transmission;
wherein each of the multiple resource occasions for sidelink feedback channel transmission is periodically occurred.

25. The wireless communication method of claim 24, wherein at least one parameter relevant to transmission opportunities on the multiple resource occasions for sidelink feedback channel transmission is pre-configured.

26. The wireless communication method of claim 25, wherein the at least one parameter comprises a number of the multiple resource occasions for sidelink feedback channel transmission.

27-32. (canceled)

33. The wireless communication method of claim 25, wherein locations of the multiple resource occasions of sidelink feedback channel are determined based on a minimum PSSCH-to-PSFCH feedback offset, wherein the minimum PSSCH-to-PSFCH feedback offset is the minimum number of slots between the last slot carrying the sidelink shared channel and a slot carrying the sidelink feedback channel.

34. The wireless communication method of claim 25, wherein the UE determines an earliest location to transmit sidelink feedback channel among the multiple resource occasions for sidelink feedback channel transmission based on LBT result of channel access over the multiple resource occasions.

35-45. (canceled)
